(19) United States
(12) Patent Application Publication
(10) Pub. No.: US 2021/0240872 A1
(43) Pub. Date: Aug. 5, 2021

(54) Method for Determining a Design of an Energy System, And Energy System

(71) Applicant: Siemens Aktiengesellschaft, München (DE)

(72) Inventors: Simon Ackermann, München (DE); Martin Kautz, Erlangen (DE); Jochen Schäfer, Nürnberg (DE); Andrei Szabo, Ottobrunn (DE); Sebastian Thiem, Neustadt an der Aisch (DE)

(73) Assignee: Siemens Aktiengesellschaft, München (DE)

(21) Appl. No.: 17/050,551

(22) PCT Filed: Apr. 1, 2019
(86) PCT No.: PCT/EP2019/058163

§ 371 Date: Oct. 26, 2020

(30) Foreign Application Priority Data
Apr. 27, 2018 (EP) 18169710.3

(51) Int. Cl. G06F 30/10; G06Q 10/04; G06Q 10/06; G06Q 30/00

(52) U.S. Cl. CPC G06F 30/10; G06Q 10/04; G06F 2111/08; G06Q 30/018; G06Q 10/06313

(57) ABSTRACT

Various embodiments include a method for determining a design of an energy system comprising: providing a plurality of values of a parameter of an optimization method using an extraction of the values according to a probability distribution of the parameter; specifying a respective single-target function of the energy system for each of the plurality of values; forming an overall target function using the single-target functions; and extremizing the overall target function using the optimization method.

### CROSS-REFERENCE TO RELATED APPLICATIONS

This application is a U.S. National Stage Application of International Application No. PCT/EP2019/058163 filed Apr. 1, 2019, which designates the United States of America, and claims priority to EP Application No. 18169710.3 filed Apr. 27, 2018, the contents of which are hereby incorporated by reference in their entirety.

### TECHNICAL FIELD

The present disclosure relates to design of an energy system. Various embodiments include methods for determining a design of an energy system by means of an optimization method and/or energy systems of which the components are designed according to a method described herein.

### BACKGROUND

Energy systems, for example, multimodal energy systems, provide at least one form of energy to an energy consumer, for example, a building, an industrial facility, or a private facility, wherein the provision may take place in particular by means of a conversion of various forms of energy, by means of a transport of the various forms of energy, and/or by means of stored forms of energy. In other words, the various forms of energy, in particular heat, cold, and/or electrical energy, are coupled by means of the (multimodal) energy system with respect to their generation, their provision, and/or their storage.

It is typical to design energy systems in an optimal manner by means of an energy system design method. For this purpose, a mathematical model of the energy system is typically used which enables optimization of the energy system with respect to a target function, by means of a numerical optimization method. For this purpose, a plurality of parameters (input parameters), for example, predicting load profiles and/or state measurements, are typically required for parameterizing the mathematical model. The parameters required for parameterization, for example, load time series, energy prices, and/or weather data, are specified deterministically. As a result, the energy system is also optimized deterministically based on the deterministic parameters. An energy system design method is described, for example, in the document “Project-level multi-modal energy system design—Novel approach for considering detailed component models and example case study for airports”, Sebastian Thiem et al., Energy, Volume 133, pages 691-709, (2017). In known energy system methods, it is necessary to make assumptions about the future development of the values of the parameters. For example, it is not known how the price of gas will develop in the future. Therefore, the future value of the gas price is specified by means of a plausibility assumption. Only this plausible value of the gas price is taken into consideration in known energy system design methods. However, as a result, it becomes difficult to design the energy system in an optimal manner, since said design may depend significantly on the apparently plausible assumptions which have been made.

### SUMMARY

The teachings of the present disclosure describe an improved energy system design method. For example, some embodiments include a method for determining a design of an energy system by means of an optimization method, comprising the steps of:
Providing a plurality of values (421) of at least one parameter of the optimization method by means of an extraction of the values (421) according to a probability distribution (42) of the parameter;
Specifying a respective single-target function of the energy system for each of the values (421) of the parameter;
Forming an overall target function by means of the single-target functions; and
Extremizing the overall target function by means of the optimization method.

In some embodiments, the overall target function is formed by means of a sum of the single-target functions.

In some embodiments, at least one secondary condition is provided for each of the single-target functions, wherein the secondary conditions are taken into consideration when extremizing the overall target function.

In some embodiments, a normal distribution is used as a probability distribution (42).

In some embodiments, the extraction of the values (421) of the parameter takes place by means of a Monte Carlo method.

In some embodiments, an electrical, thermal, chemical, and/or mechanical load, a price, and/or at least one metrological quantity is/are used as a parameter.

In some embodiments, the overall costs of the energy system and/or the carbon dioxide emission of the energy system and/or the primary energy use of the energy system is/are used as single-target functions.

In some embodiments, the value of each single-target function is calculated according to the determined design of the energy system and by means of its associated value (421) of the parameter.

In some embodiments, a probability distribution of the single-target functions is calculated by means of the determined design of the energy system.

As another example, some embodiments include an energy system, comprising at least a plurality of components for providing one or a plurality of forms of energy, characterized in that the components have a design according to a method as described herein.

In some embodiments, the energy system is configured as a multimodal energy system.

### BRIEF DESCRIPTION OF THE DRAWINGS

Additional advantages, features, and details of the present disclosure are apparent in the description of the exemplary embodiments which are described below, and with the aid of the drawings. The following are depicted schematically:

FIG. 1 shows a depiction of an extraction of values of a parameter according to a probability distribution;

FIG. 2 shows a distribution of the values of the single-target functions corresponding to the values of the parameter, and a probability distribution of the single-target functions derived therefrom; and

FIG. 3 shows a schematic flow chart of an example method incorporating teachings of the present disclosure.

### DETAILED DESCRIPTION

The methods described herein and incorporating teachings of the present disclosure for determining a design of an energy system by means of an optimization method may include at least the following steps:
Providing a plurality of values of at least one parameter of the optimization method by means of an extraction of the values according to a probability distribution of the parameter;
Specifying a respective single-target function of the energy system for each of the values of the parameter;
Forming an overall target function by means of the single-target functions; and
Extremizing the overall target function by means of the optimization method.

The methods for determining the design of the energy system corresponds to an energy system design method may be referred to as an energy system design method. By means of the methods taught herein, the design of the energy system, in particular the determination of its components, is determined. The design of the energy system may comprise a determination and/or ascertainment and/or specification of the components which the energy system includes. Furthermore, the design of the energy system may comprise the size and/or capacities of its components, the cost of the components, for example, the cost of energy storage, energy flows, and/or power flows. In other words, any system quantity of the energy system and/or any quantity characterizing the energy system may be taken into consideration during optimization, in the sense that an optimal value of the system quantity or of the characterizing quantity is determined. Taking the system quantity and/or characterizing quantity into consideration may take place by means of including them in the single-target function or overall target function.

In other words, the design of the energy system refers in particular to its structure and/or its construction with respect to its components, its size, and/or its profitability analysis. The optimal design of the energy system is also referred to as an optimization problem. By means of the optimization method, this optimal design of the energy system, i.e., for example, its structure, its size, its profitability analysis, and/or the like, is determined.

The energy system may comprise one or a plurality of power generators, CHP generation plants, in particular micro-CHP plants, gas boilers, diesel generators, heat pumps, compression refrigerating machines, absorption refrigerating machines, pumps, district heating networks, energy transfer lines, wind turbines or wind energy systems, photovoltaic systems, biomass systems, biogas systems, waste incineration facilities, industrial facilities, conventional power plants, and/or the like, as components.

A quantity is a parameter of the optimization method if its value or its values are considered to be constant during the optimization. In other words, the parameter is fixed but arbitrary. Parameters may also be referred to as input parameters. A quantity is a variable of the optimization method if its value or its values vary during the optimization. In other words, by means of the optimization method, a best-possible or optimal value of the variables is determined.

Secondary conditions, boundary conditions, or constraints, referred to here jointly as secondary conditions, are conditions, characteristics, and/or relations which the parameters and/or variables of the optimization method must fulfill. These may be provided as an equation and/or an inequality, and/or explicitly describe a quantity of allowable values of the parameters and/or allowable values of the variables.

The optimization method is, for example, a mathematical and/or numerical optimization method, in particular a simplex method, which, for example, is executable by means of a computing device, in particular by means of a computer. By means of the optimization method, the overall target function is extremized, i.e., maximized or minimized. It is not necessary to calculate an exact maximum or minimum. It is sufficient to determine an approximately optimal design (solution), for example, by means of an approximation algorithm and/or by means of a determination of a threshold value for an error in the optimization method.

In some embodiments, at least one parameter is provided for the optimization method. In some embodiments, the values of the parameter are specified by means of extraction, according to its probability distributions or distribution. In other words, the parameter is a stochastic random variable (not to be confused with the variables of the optimization method), which assumes various values according to its probability distribution. The values of the parameter thus constitute a sample with respect to the probability distribution and may also be referred to as sample values. A plurality of such stochastic parameters having corresponding probability distributions may be provided. In addition, deterministic parameters may be provided.

A single-target function of the energy system is specified for each of the extracted values of the parameter. In other words, the single function models the energy system for the extracted value of the parameter. In some embodiments, an overall target function is formed from the single-target functions which are formed by the extracted values of the parameter. In some embodiments, the overall target function is extremized by means of the optimization method. As a result, a plurality of similar energy systems corresponding to the number of the extracted values of the parameter is optimized.

In other words, the plurality of values of the parameter which were stochastically extracted (samples) are taken into consideration in the optimization method and thus when determining the design of the energy system. Taking the various values of the parameter into consideration takes place via the overall target function which is optimized as well as possible, i.e., extremized, by means of the optimization method. Thus, the extracted values of the parameter are incorporated into the optimization. However, known methods consider only a most plausible value of the parameter.

In other words, a scenario, i.e., a model of the energy system, is provided for each (extracted) value of the parameter. A single-target function of the energy system corresponds to each scenario. For example, the parameter is a gas price, wherein a single-target function is provided for each value of the gas price. It could be figuratively stated that an energy system exists for each value of the parameter, wherein by means of the formation of the overall target function, this plurality of existing energy systems is advantageously considered in parallel by means of the optimization method, and is simultaneously designed in an optimal manner.

In some embodiments, the probability distribution of the parameter is taken into consideration via the sample values of the parameter when determining the design of the energy system. In other words, the optimization method has knowledge about the probability distribution of the parameter. As a result, the energy system is not deterministically optimized within the scope of a parameter variation or sensitivity analysis, as provided in the prior art, but rather, a plurality of parallel scenarios is considered simultaneously and optimized according to the probability distribution of the parameter. In particular, a weighting of the scenarios is typically not required, since the values of the parameter are already extracted according to its probability distribution and are thus weighted correspondingly. However, an at least partial weighting of the various scenarios or single-target functions may be provided.

In some embodiments, the determination of samples of the stochastic parameter for an energy system design problem, and the parallel and simultaneous consideration of this plurality of samples within the optimization method. As a result, a stochastic optimization of the energy system with respect to the parameter advantageously takes place.

In some embodiments, the overall target function is formed by means of a sum of the single-target functions. A weighted sum may be provided for forming the overall target function from the single-target functions. However, a weighting is not necessarily required, since the values of the parameter are already extracted according to its probability distribution. By forming the overall target function by means of the sum of the single-target functions, the extracted values of the parameter which correspond to the single-target functions of the energy system are taken into consideration in parallel or simultaneously in the optimization method. In other words, the overall target function is optimized taking into consideration the probability distribution of the parameter.

The discussed approach can be illustrated with the aid of a gas price. The same applies correspondingly for different or additional stochastic parameters. An example of the parameter is the gas price. In the context of the present disclosure, said gas price is a random variable which assumes various values according to a probability distribution. This because the future values of the gas price can be specified only with a certain probability. The probability can describe, depict, and/or model the uncertainty of the gas price for the future.

In other words, Gᵢ=G(pᵢ), where G denotes the gas price, Gᵢ denotes i-th value of the gas price G, and pᵢ denotes the probability of the i-th value Gᵢ of the gas price G. In other words, pᵢ is the probability that the gas price G has the value Gᵢ. A single-target function Zᵢ is specified for each value of the gas price. The overall target function Z is formed by the sum Z=ΣᵢZᵢ of the single-target functions Zᵢ. A weighted sum Z=ΣᵢλᵢZᵢ having weighting factors λᵢ may be provided. Typically, the weighting factors λᵢ have a value in the closed range from zero to one. Furthermore, various secondary conditions may be associated with each single-target function. The secondary conditions of the single-target functions and/or other secondary conditions may be associated with the overall target function. The overall target function is extremized taking into consideration the secondary conditions, i.e., optimized with respect to its value, whereby the design of the energy system is determined taking into consideration the values of the gas price Gᵢ.

In some embodiments, at least one secondary condition is provided for each of the single-target functions, wherein the secondary conditions are taken into consideration when extremizing the overall target function. As a result, the secondary conditions which are associated with one of the values of the parameter and which may be a function of the parameter are taken into consideration in the optimization method in parallel, i.e., holistically via the formation of the overall target function. As a result, the determination of the design of the energy system may be further improved.

In some embodiments, a normal distribution is used as a probability distribution. Typical parameters are normally distributed, i.e., their values are distributed according to a normal distribution. A further advantage is that a normal distribution can be generated numerically in an efficient manner.

In some embodiments, the extraction of the values of the parameter takes place by means of a Monte Carlo method. This may be particularly advantageous if the probability distribution of the parameter is not sufficiently known. Furthermore, it is possible to implement the Monte Carlo method numerically in a particularly efficient manner.

In some embodiments, the Monte Carlo method enables an efficient and rapid numeric provision of the values of the parameter according to its probability distribution. In other words, a plurality of samples is extracted for the parameter by means of the Monte Carlo method. In other words, the Monte Carlo method enables a representative depiction of the probability distribution of the stochastic parameter. Furthermore, the Monte Carlo method enables a provision of a plurality of similar random experiments (scenarios), wherein the random experiments correspond to the values of the parameter.

In some embodiments, an electrical, thermal, chemical, or/and mechanical load, a price, and/or at least one metrological quantity is/are used as a parameter. As a result, a plurality of stochastic parameters, in particular prices and/or mechanical loads and/or metrological quantities, are taken into consideration in the optimization method, and thus when determining the design of the energy system. In particular, the provision of extracted values of a plurality of parameters is provided. As a result, a plurality of stochastic parameters of the energy system is taken into consideration in its design, i.e., in the optimization method. As a result, the energy system is designed stochastically in an optimal manner.

In some embodiments, the overall costs of the multimodal energy system and/or the carbon dioxide emission of the multimodal energy system and/or the primary energy use of the energy system is/are used as a single-target function. As a result, the overall costs of the energy system, the carbon dioxide emissions, and/or the primary energy use of the energy system are optimized, in particular minimized. For example, the carbon dioxide emission of the energy system or the overall carbon dioxide emission of the energy system constitutes the single-target functions.

Furthermore, the overall costs of the energy system, which are typically made up of investment costs, variable investment costs, operating costs, and/or maintenance costs and/or servicing costs, use costs, and/or energy costs, and/or start-up costs, may be used and minimized as single-target functions. In other words, the overall costs of the energy system are minimized, taking into consideration the volatility of the parameter.

In some embodiments, the value of each single-target function is calculated according to the determined design of the energy system and by means of its associated value of the parameter. In other words, after determining the design of the energy system, i.e., after extremizing the overall target function, each of the single-target functions is evaluated for the associated value of the parameter. As a result, the aforementioned value of the single-target function results, which, for example, corresponds to the overall cost of an energy system designed according to the single-target function. As a result, a probability distribution of the single-target functions, and thus a probability distribution of the scenarios corresponding to the values of the parameter, is advantageously calculated and/or provided. With the aid of this provision, the probability with which, for example, the installation of a component is worthwhile, becomes apparent. In other words, it is advantageous to calculate a probability distribution of the single-target functions by means of the determined design of the energy system.

As a result, the distribution of the target functions can be derived. If the single-target functions are provided, for example, by the respective overall costs (for each value of the parameter) of the energy system, a probability distribution of the overall costs which, for example, is determined by means of a histogram, thus results by means of the determination of the probability distribution of the single-target functions. From this, for example, the probability distribution of the profit for an operator of the energy system can be depicted. In some embodiments, the probability distribution of the carbon dioxide emissions and/or the primary energy use can be determined.

The energy system according to the present disclosure comprises at least a plurality of components for providing one or several forms of energy, wherein the energy system according to the present invention is characterized in that the components have a design according to a method as described herein. In some embodiments, the energy system is thereby formed as a multimodal energy system.

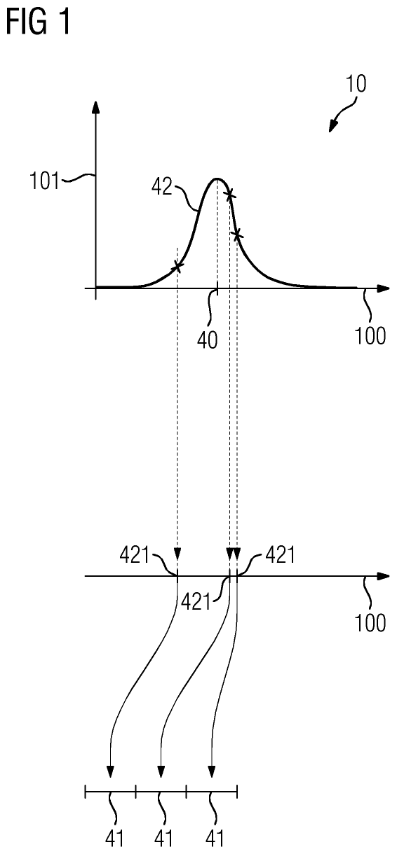

Similar, equivalent, or similarly acting elements may be provided with the same reference signs in one of the figures or in the figures. FIG. 1 symbolizes the extraction of values (samples) of at least one parameter, in particular one or a plurality of parameters, according to a probability distribution 42 existing for the parameter. The probability distribution 42 of the parameter is plotted in a diagram 11 of FIG. 1. The parameter is plotted on the abscissa 100 of the diagram 11. The probability of a particular value of the parameter is plotted on the ordinate 101 of the diagram 11. The diagram 11 thus depicts the probability distribution 42 of the parameter.

According to the probability distribution 42, a plurality of values the parameter is depicted. Here, the extraction of three values of the parameter is illustrated by way of example. The extracted values of the parameter are identified by the reference signs 421. According to the extracted values 421 of the parameter, single-target functions of the energy system are specified and/or determined which correspond to various scenarios 41. The various scenarios 41 are taken into consideration in parallel in the optimization method.

The approach will be described with the aid of a simplified and non-limiting exemplary embodiment, in which the parameter is a gas price. The gas price, and thus the parameter, is normally distributed with respect to a current period of time for the five years following the current period of time. In other words, the uncertainty of the values of the gas price within the next five years is modeled or estimated by a normal distribution (Gauss distribution). The probability distribution 42 is thus a normal distribution. The average value or expected value of the parameter is indicated by the reference sign 40.

According to the normal distribution, for example, twenty values of the gas price are extracted (samples or sample values). This extraction is symbolized in FIG. 1 by the vertical dashed arrows (in FIG. 1, symbolically only for three samples 421). The samples may be referred to as scenarios with respect to the energy system, or also as periods with respect to the optimization method.

Corresponding to the extracted twenty values of the gas price, twenty single-target functions of the energy system are provided or specified, possibly having associated secondary conditions. The twenty single-target functions or scenarios are considered jointly and in parallel within the optimization method. However, the optimization method or an optimization algorithm of the optimization method does not determine twenty individual solutions, but rather, a common design of the energy system is determined. This takes place by means of a formation of an overall target function by means of the single-target functions. However, in the determined design of the energy system, all twenty values of the gas price, and thus their probability distributions, are taken into consideration. In other words, twenty different designs of the energy system are not determined. Rather, an optimal design of the energy system is determined for the totality of the twenty values of the gas price by means of the optimization method. The overall costs, the carbon dioxide emissions, and/or a primary energy use of the energy system may respectively be used as single-target functions and thus as an overall target function.

After determining the optimal design of the energy system, i.e., with knowledge of an optimal solution, the single-target functions may be evaluated individually, i.e., their associated value of the parameter, in particular their associated value of the gas price, and the determined optimal values of the variables of the optimization, are used in at least one or a plurality of the single-target functions. A distribution of values of single-target functions thereby results, which enables a weighting of the scenarios. For example, as a result, a distribution of the overall costs of the energy system is determined, in particular scaled to one year. It may be advantageous not to consider an overall optimization time horizon for each of the scenarios, but rather only a limited time period, for example, specified days, months, and/or periods.

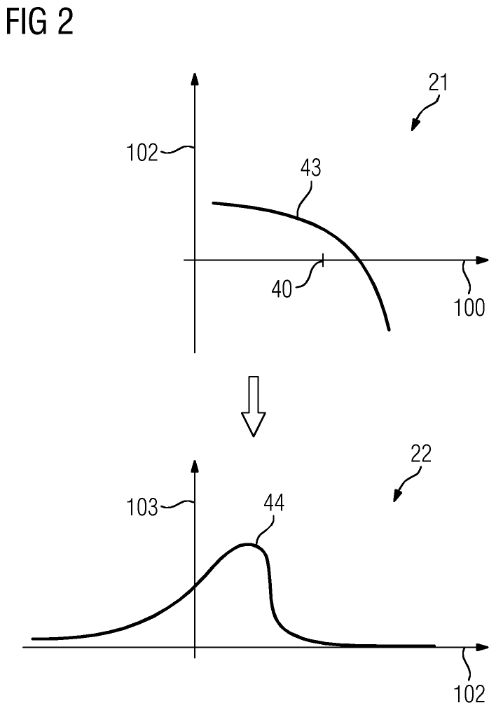

FIG. 2 depicts a diagram 21 of the distribution 43 of the values of the single-target functions as a function of the parameter, as well as another diagram 22 of the probability distributions of the values of the single-target functions or the probability distributions of the single-target functions. The parameter, in particular the gas price, is thus plotted on the abscissa 100 of the diagram 21. The single-target function or the values of the single-target functions are plotted on the ordinate 102 of the diagram 21. The totality of the values of the single-target functions may also be referred to as the success factor. The curve thus constitutes the success factor as a function of the parameter.

The average value or expected value of the parameter is indicated by reference sign 40. As of a certain value of the parameter, which is specified here by the intersection of the curve 43 with the abscissa 100, the success factor is negative, so that as of this value of the parameter, in particular the installation or the operation of a component, for example, a micro-CHP plant, is no longer profitable. Thus, it is subsequently possible to make a probabilistic estimation of the efficiency of the determined design of the energy system.

The probability distribution 44 of the single-target functions may also be determined from the additional diagram 21 depicted in FIG. 2. This probability distribution 44 is depicted in another diagram 22. The value of the single-target function or the success factor is plotted on the abscissa 102 of the additional diagram 22. The associated probability is plotted on the ordinate 103 of the additional diagram 22. A maximum in the probability may result for a particular value of one of the single-target functions. If the single-target functions are formed by the overall costs of the energy system, the probability of the occurrence of the overall costs of the designed energy system is thereby depicted. As a result, it is possible to make an improved determination of the design of the energy system which is not based on human assumptions, but which can be determined in a probabilistic and thus objective manner.

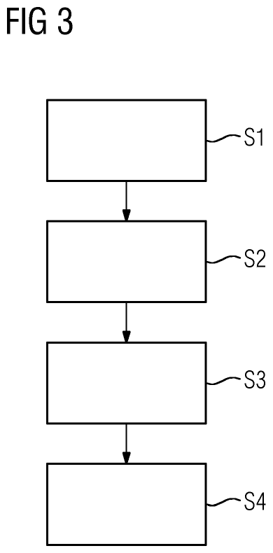

FIG. 3 depicts a flow chart of the method incorporating teachings of the present disclosure. In a first step S1, a plurality of values of at least one parameter, in particular for a plurality of parameters, of the optimization method, is provided by means of an extraction of the values of the parameter according to a probability distribution of the parameter. In other words, the values of the parameter form a sample or sample values, wherein the parameter forms a random variable in the probabilistic sense, having the aforementioned probability distribution.

In a second step S2, a respective associated single-target function of the energy system is specified for each value of the parameter. In other words, the single-target function characterizes the energy system for the value of the parameter. Thus, a plurality of similar energy systems is figuratively considered, of which the value of the parameter differs (scenarios).

In a third step S3, an overall target function is formed by means of the single-target functions. The overall target function may be formed by means of the mathematical sum, and/or by means of a weighted mathematical sum, of the single-target functions. Further equivalent configurations, for example, affine configurations and/or configurations by means of a plurality of scalar multiplications, may be provided.

In a fourth step S4, the overall target function is extremized by means of the optimization method. In other words, the determination of the design of the energy system takes place by means of the extremization of the overall target function. As a result, the energy system may be designed in an optimal manner, taking into consideration the stochastic variation of the parameter.

The optimization method may take place by means of a computing device, in particular by means of a computer. For this purpose, in particular an optimization algorithm is provided. Furthermore, the optimization problem may be formed linearly or nonlinearly. In particular, a simplex method (also simplex algorithm) is provided as the optimization method for a linear optimization problem, or the optimization method comprises a simplex method.

The teachings of the present disclosure enable a particularly advantageous determination of a design of an energy system, taking into consideration the stochastic variation of at least one parameter, in particular a plurality of parameters. The stochastic behavior of the parameter or the parameters is taken into consideration in the optimization method. An optimization method in particular does not take place for each value of the parameter, but rather an extremization of the overall target function takes place, holistically taking into consideration the stochastic variation of the parameter with respect to the extracted values of the parameter.

The implementation of presently described processes or process steps, in particular the optimization method, may take place with the aid of instructions which are present in computer-readable storage media or in volatile computer memories (referred to below collectively as computer-readable memory). Computer-readable memories include, for example, volatile memories such as caches, buffers, or RAM, and non-volatile memories such as removable media or hard disks. The functions or method steps described above may exist in the form of at least one instruction set in or on a computer-readable memory. The functions or method steps are not linked to a particular instruction set, or to a particular form of instruction sets, or to a particular storage medium, or to a particular processor, or to particular execution schemes, and may be executed by software, firmware, microcode, hardware, processors, or integrated circuits in stand-alone operation or in any combination.

A wide variety of processing strategies may be used, for example, serial processing by a single processor, multiprocessing, multitasking, or parallel processing. The instructions may be stored in local memories; however, it is also possible to store the instructions on a remote system, in particular a cloud, for example, MindSphere from Siemens AG, and to access it via a network. The term “computing device” as used here comprises processors and processing means in the broadest sense, for example, servers, universal processors, graphics processors, digital signal processors, application-specific integrated circuits (ASICs), programmable logic circuits such as FPGAs, discrete analog or digital circuits and any combinations thereof, including all other processing means known to those skilled in the art or developed in the future. Processors may be made up of one or a plurality of devices. If a processor is made up of a plurality of devices, they may be configured for the parallel or sequential processing of instructions.

Although the present disclosure has been illustrated and described in detail in part via the exemplary embodiments, the scope of the present disclosure is not limited by the disclosed examples, or other variations may be derived therefrom by those skilled in the art, without departing from the protective scope of the present disclosure.

### LIST OF REFERENCE CHARACTERS

51 First step
52 Second step
53 Third step
54 Fourth step
11 Diagram
21 Diagram
22 Diagram
40 Expected value
41 Scenario
42 Probability distribution
421 Value of the gas price
100 Abscissa—gas price
101 Ordinate—probability of a gas price
102 Ordinate—success factor
103 Ordinate—probability of a success factor

What is claimed is:

1. A method for determining a design of an energy system, the method comprising:
providing a plurality of values of a parameter of an optimization method using an extraction of the values according to a probability distribution of the parameter;
specifying a respective single-target function of the energy system for each of the plurality of values;
forming an overall target function using the single-target functions; and
extremizing the overall target function using the optimization method.

2. The method as claimed in claim 1, wherein forming the overall target function includes using a sum of the single-target functions.

3. The method as claimed in claim 1, further comprising taking into consideration a respective secondary condition for each single-target functions.

4. The method as claimed in claim 1, wherein the probability distribution includes a normal distribution.

5. The method as claimed in claim 1, wherein extracting the values of the parameter includes using a Monte Carlo method.

6. The method as claimed in claim 1, wherein a parameter includes an electrical, thermal, chemical, and/or mechanical load, a price, and/or at least one metrological quantity.

7. The method as claimed in claim 1, wherein at least one of the single-target functions includes the overall costs of the energy system and/or the carbon dioxide emission of the energy system and/or the primary energy use of the energy system.

8. The method as claimed in claim 1, further comprising calculating the value of each single-target function according to the determined design of the energy system and using an associated value of the parameter.

9. The method as claimed in claim 1, further comprising calculating a probability distribution of the single-target functions using the determined design of the energy system.

10-11. (canceled)
